(19) United States
(12) Patent Application Publication
(10) Pub. No.: US 2025/0391589 A1
(43) Pub. Date: Dec. 25, 2025

(54) CABLE AND METHOD OF MANUFACTURING THE SAME

(71) Applicant: DONGGUAN LUXSHARE TECHNOLOGIES CO., LTD, Dongguan City (CN)

(72) Inventors: Charles Lloyd GRANT, Dongguan City (CN); Jinchang DAI, Dongguan City (CN); Bentao HU, Dongguan City (CN); Huanzhong YAN, Dongguan City (CN); Andrew John NOWAK, Dongguan City (CN); Henning HANSEN, Dongguan City (CN)

(73) Assignee: DONGGUAN LUXSHARE TECHNOLOGIES CO., LTD, Dongguan City (CN)

(21) Appl. No.: 19/307,204

(22) Filed: Aug. 22, 2025

Related U.S. Application Data
(63) Continuation of application No. 19/220,536, filed on May 28, 2025.
Application No. 19/220,536 is a continuation of application No. 18/224,357, filed on Jul. 20, 2023, now abandoned.

(30) Foreign Application Priority Data
Aug. 30, 2022 (CN) 202211043805.5
Aug. 23, 2024 (CN) 202411171386.2
Oct. 24, 2024 (CN) 202411498783.0

(51) Int. Cl. H01B 11/06; H01B 7/02; H01B 11/00; H01B 13/06

(52) U.S. Cl. CPC H01B 11/06; H01B 7/0208; H01B 11/002; H01B 13/06

(57) ABSTRACT

A cable includes a first core, a second core, a first insulation layer, a second insulation layer, a shielding layer, and a first grounding layer. The first insulation layer is at least partially wrapped around the first core in a circumferential direction. The second insulation layer is at least partially wrapped around the second core in the circumferential direction. The shielding layer is located outside the first insulation layer and the second insulation layer. The first grounding layer is flat, and the first grounding layer is located outside the shielding layer. The first grounding layer and the shielding layer are separated parts, and come into contact with each other. A method of manufacturing the cable is also disclosed.

### CROSS-REFERENCE TO RELATED APPLICATIONS

This patent application is a continuation-in-part of U.S. application Ser. No. 19/220,536, filed on May 28, 2025, which is a continuation application of U.S. application Ser. No. 18/224,357, filed Jul. 20, 2023, and further claims priority of a Chinese Patent Application No. 202411171386.2, filed on Aug. 23, 2024 and titled “CABLE CONNECTOR AND METHOD OF MANUFACTURING THE SAME”, and a Chinese Patent Application No. 202411498783.0, filed on Oct. 24, 2024 and titled “CABLE AND METHOD OF MANUFACTURING THE SAME”, and Chinese Patent Application No. 202211043805.5, filed Aug. 30, 2022 and title “CABLE”, the entire disclosures of which are incorporated herein by reference in their entirety.

### TECHNICAL FIELD

The present disclosure relates to a cable and a method of manufacturing the same, which belongs to the technical field of connectors.

### BACKGROUND

Cable connectors in the related art usually include a plurality of conductive terminals and a plurality of cables. The plurality of conductive terminals typically include multiple signal terminal pairs. The cables and the conductive terminals usually achieve electrical contact by soldering or welding.

The cable generally includes a first core, a second core, a first insulation layer at least partially wrapped around the first core in a circumferential direction, a second insulation layer at least partially wrapped around the second core in a circumferential direction, a shielding layer outside the first insulation layer and the second insulation layer, and an insulation skin disposed outside the shielding layer.

The shielding layer generally includes a first metal layer located in an inner side and a second metal layer located in an outer side. The first metal layer is usually an aluminum foil, and the second metal layer is usually a copper foil. By providing the first metal layer of the aluminum foil material, the shielding effect on the first core and the second core can be improved. By providing the second metal layer of the copper foil material, it is advantageous to solder or weld the second metal layer to a grounding portion of the cable connector.

Since the shielding layer needs to be at least partially wrapped around outside the first insulating layer and the second insulating layer, folding of the shielding layer is inevitable. However, in the related art, the second metal layer made of copper foil material is prone to cracking when folded. Therefore, there is still room for improvement in cables in related art.

### SUMMARY

Some embodiments of the present disclosure adopts the following technical solution: a cable including: a first core; a second core; a first insulation layer, the first insulation layer at least partially surrounding the first core in a circumferential direction; a second insulation layer, the second insulation layer at least partially surrounding the second core in the circumferential direction; a shielding layer, the shielding layer being located outside the first insulation layer and the second insulation layer, and the shielding layer at least partially surrounding the first insulation layer and the second insulation layer in the circumferential direction; and a first grounding layer, the first grounding layer being of a flat configuration and extending in a longitudinal direction of the cable as a flat strip; the first grounding layer being located outside the shielding layer; and the first grounding layer being separate from and in contact with the shielding layer.

Some embodiments of the present disclosure adopts the following technical solution: a method for manufacturing a cable, the cable including: a first core; a second core; a first insulation layer, the first insulation layer at least partially surrounding the first core in a circumferential direction; a second insulation layer, the second insulation layer at least partially surrounding the second core in the circumferential direction; a shielding layer, the shielding layer being located outside the first insulation layer and the second insulation layer, and the shielding layer at least partially surrounding the first insulation layer and the second insulation layer in the circumferential direction; and a first grounding layer, the first grounding layer being of a flat configuration and extending in a longitudinal direction of the cable as a flat strip; the first grounding layer being located outside the shielding layer; and the first grounding layer being separate from and in contact with the shielding layer; the method including:
providing the first core and wrapping the first insulation layer around the first core;
providing the second core and wrapping the second insulation layer around the second core;
providing the shielding layer and disposing the shielding layer outside the first insulation layer and the second insulation layer; and
providing the first grounding layer and attaching the first grounding layer to an outer side of the shielding layer.

### BRIEF DESCRIPTION OF DRAWINGS

FIG. 1 is a schematic perspective view of a cable connector in accordance with a first embodiment of the present disclosure;

FIG. 2 is a front view of FIG. 1;

FIG. 3 is a bottom view of FIG. 1;

FIG. 4 is a partially exploded perspective view of FIG. 1, in which a built-in circuit board is separated;

FIG. 5 is a top view of FIG. 4;

FIG. 6 is a bottom view of FIG. 4;

FIG. 7 is a top view of the built-in circuit board shown in FIG. 4;

FIG. 8 is a bottom view of the built-in circuit board shown in FIG. 4;

FIG. 9 is a partially exploded perspective view of FIG. 1;

FIG. 10 is a partially exploded perspective view of FIG. 9 from another angle;

FIG. 11 is a partial enlarged view of frame portion B in FIG. 9;

FIG. 12 is a partial enlarged view of frame portion C in FIG. 10;

FIG. 13 is a partial enlarged view of frame portion D in FIG. 9;

FIG. 14 is a partial enlarged view of frame portion E in FIG. 10;

FIG. 15 is a further exploded perspective view of FIG. 9;

FIG. 16 is an exploded perspective view of FIG. 15 from another angle;

FIG. 17 is a schematic cross-sectional view taken along line F-F in FIG. 1; and

FIG. 18 is a partially enlarged view of frame portion H in FIG. 17;

FIG. 19 is a front view of a first cable in accordance with a second embodiment of the present disclosure;

FIG. 20 is a bottom view of FIG. 19;

FIG. 21 is a top view of FIG. 19;

FIG. 22 is a structural view of a shielding layer in FIG. 19;

FIG. 23 is a schematic cross-sectional structure view of the shielding layer of the first cable in accordance with an embodiment of the present disclosure;

FIG. 24 is a schematic cross-sectional structure view of the shielding layer of the first cable in accordance with another embodiment of the present disclosure;

FIG. 25 is a schematic cross-sectional structure view of area J in FIG. 22 in one embodiment;

FIG. 26 is a schematic cross-sectional structure view of area J in FIG. 22 in another embodiment;

FIG. 27 is a front view of the first cable in accordance with a third embodiment of the present disclosure;

FIG. 28 is a schematic cross-sectional view of the first cable in FIG. 27 taken along a cross-section thereof; and

FIG. 29 is a cross-sectional view of FIG. 28 in another embodiment.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

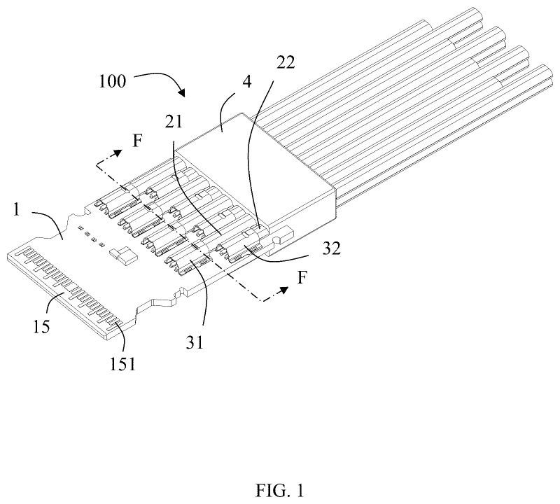

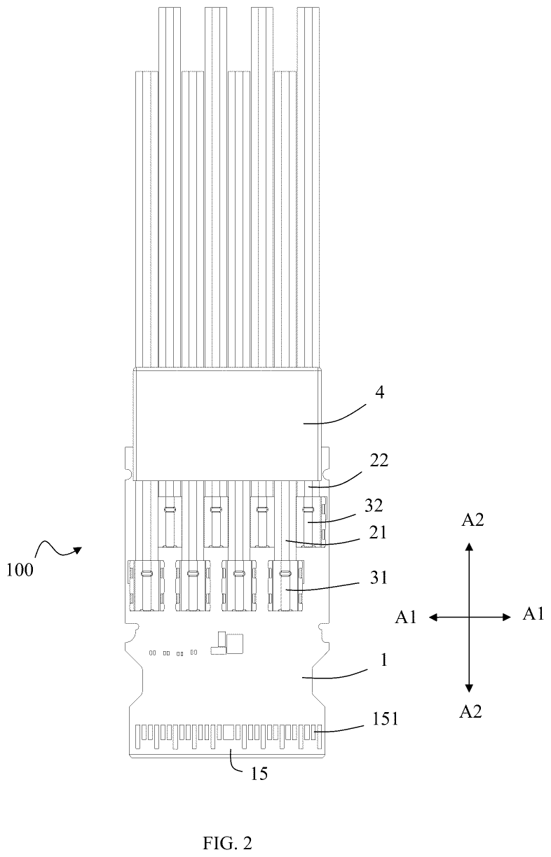

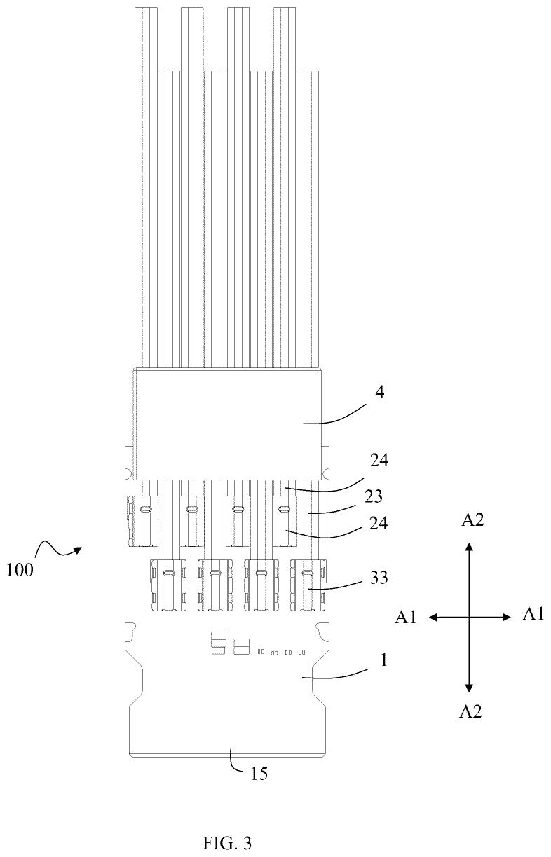

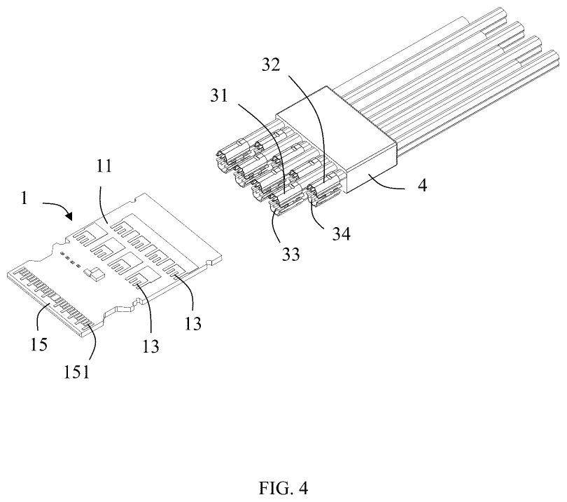

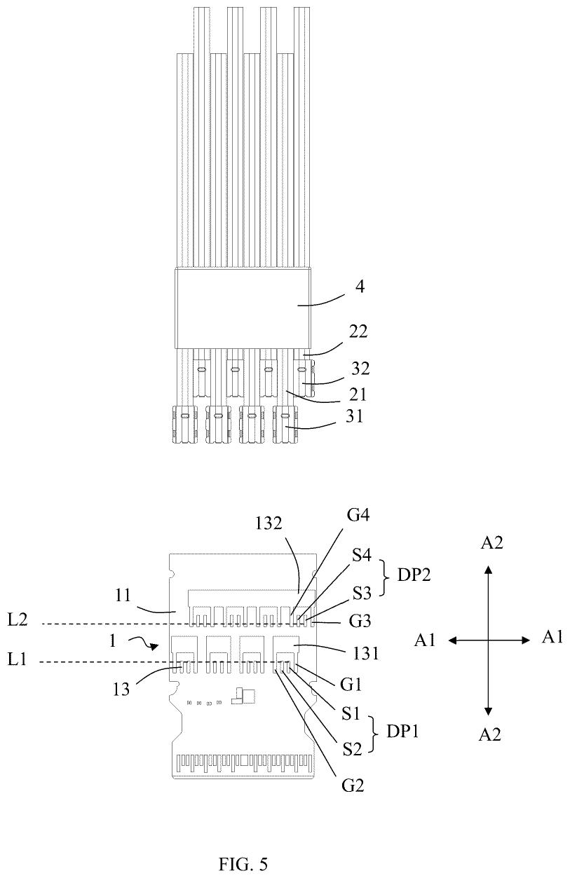

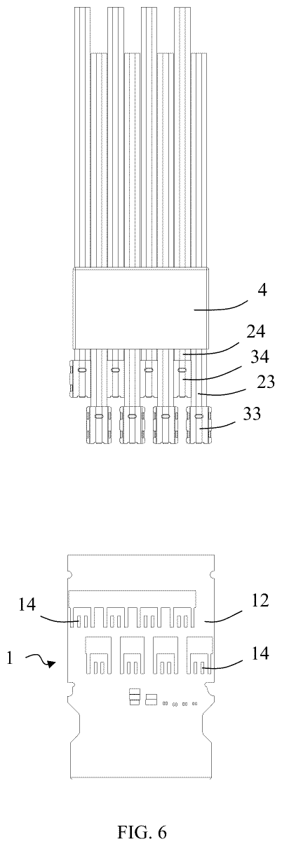

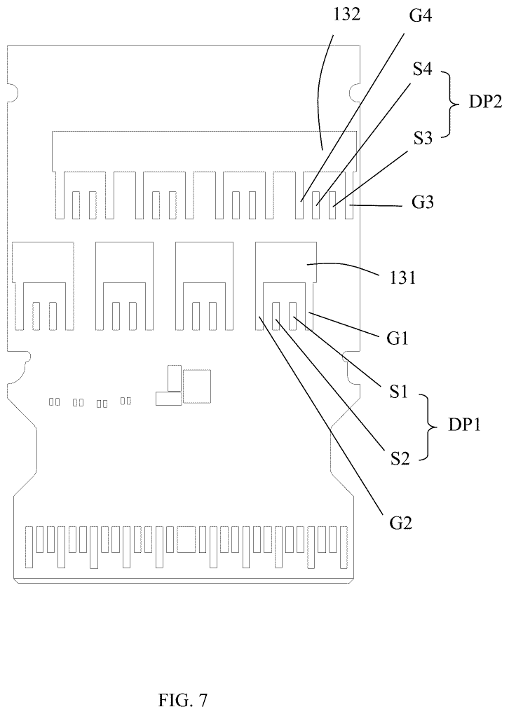

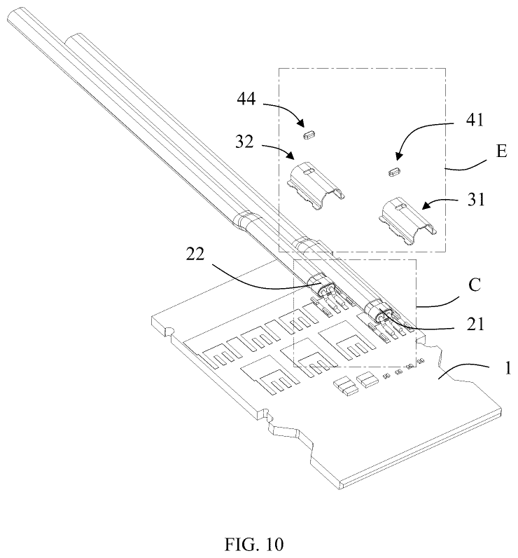

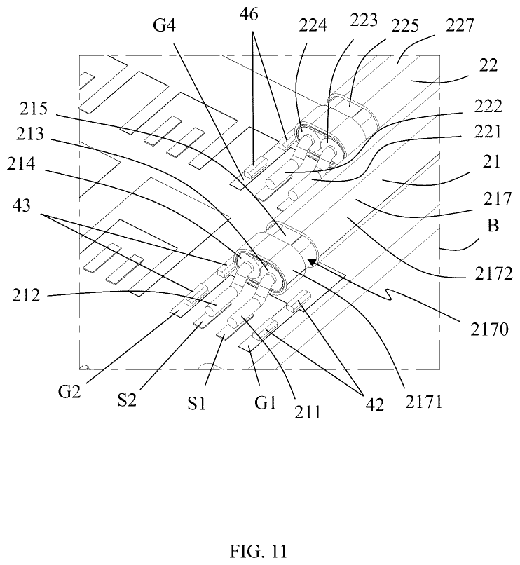

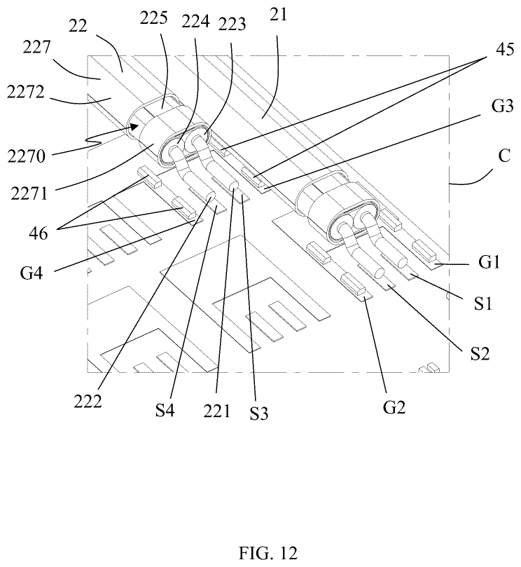

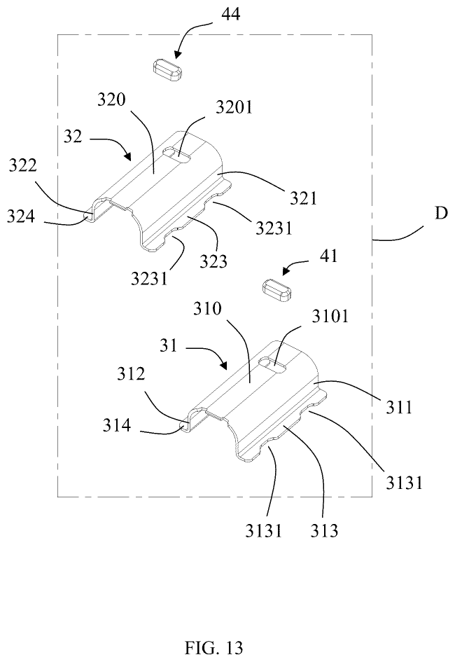

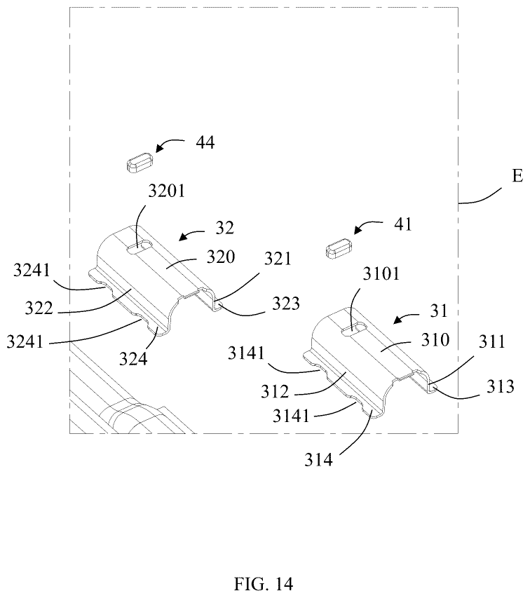

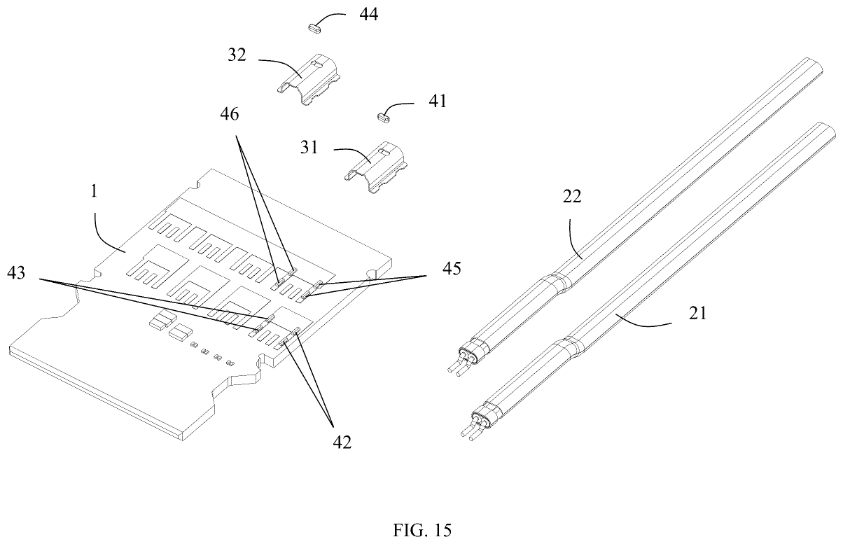

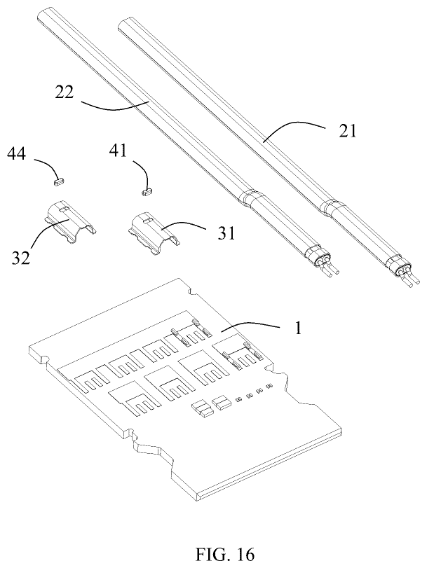

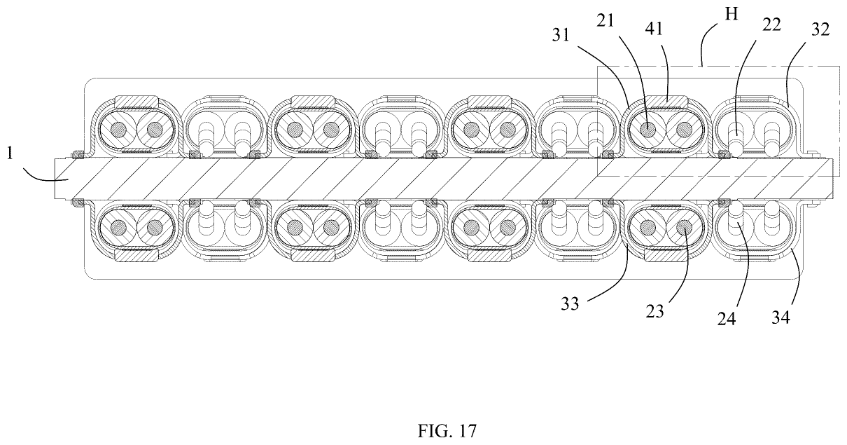

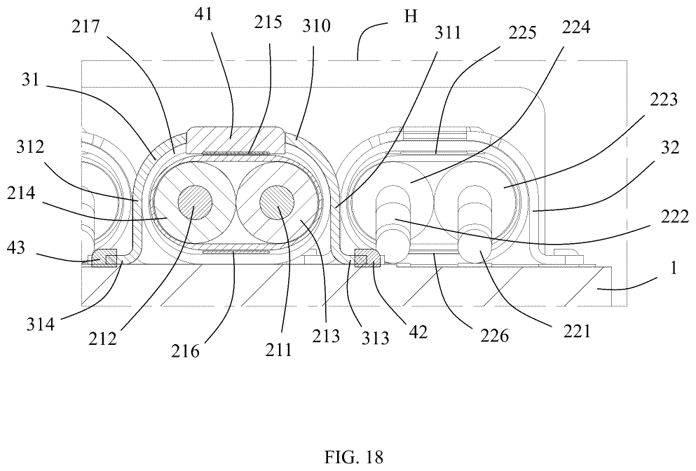

Referring to FIG. 1 to FIG. 18, some embodiments of the present disclosure disclose a cable connector 100, which includes a built-in circuit board 1, a plurality of cables electrically connected to the built-in circuit board 1, a plurality of metal shields covering connection portions of the built-in circuit board 1 and the cables, and a fixing block 4 fixed on the cables.

Referring to FIG. 1 to FIG. 7, in the illustrated embodiment of the present disclosure, the built-in circuit board 1 includes a first surface 11 (for example, an upper surface), a second surface 12 (for example, a lower surface) opposite to the first surface 11, a plurality of first conductive pads 13 exposed on the first surface 11, and a plurality of second conductive pads 14 exposed on the second surface 12.

The plurality of first conductive pads 13 include a first signal conductive pad S1, a second signal conductive pad S2 disposed adjacent to the first signal conductive pad S1, a first ground pad G1 disposed adjacent to the first signal conductive pad S1 and located on one side of the first signal conductive pad S1, and a second ground pad G2 disposed adjacent to the second signal conductive pad S2 and located on one side of the second signal conductive pad S2. The first signal conductive pad S1 and the second signal conductive pad S2 are arranged side by side along a first direction A1-A1 (for example, a left-right direction) to form a first signal pair DP1. The first ground pad G1 and the second ground pad G2 are located on two sides of the first signal pair DP1, respectively, along the first direction A1-A1. In an embodiment of the present disclosure, the first signal pair DP1 is a first differential pair for transmitting signals.

In the illustrated embodiment of the present disclosure, both the first ground pad G1 and the second ground pad G2 are in a straight strip shape and extend along a second direction A2-A2 (for example, a front-rear direction). The second direction A2-A2 is perpendicular to the first direction A1-A1. A width of the first ground pad G1 along the first direction A1-A1 is greater than a width of the first signal conductive pad S1 along the first direction A1-A1, and is also greater than a width of the second signal conductive pad S2 along the first direction A1-A1. A width of the second ground pad G2 along the first direction A1-A1 is greater than the width of the first signal conductive pad S1 along the first direction A1-A1, and is also greater than the width of the second signal conductive pad S2 along the first direction A1-A1. With this arrangement, the first ground pad G1 and the second ground pad G2 can provide a better shielding effect for the first signal pair DP1, thereby improving the quality of signal transmission.

In the illustrated embodiment of the present disclosure, in order to further improve the quality of signal transmission, the plurality of first conductive pads 13 further include a first connection portion 131 connecting one end of the first ground pad G1 and one end of the second ground pad G2, so that the first ground pad G1, the second ground pad G2 and the first connection portion 131 are of a U-shaped configuration. The first signal pair DP1 is located in a U-shaped space of the U-shaped configuration.

Specifically, in the illustrated embodiment of the present disclosure, a length of the first connection portion 131 along the second direction A2-A2 is greater than the width of the first ground pad G1 along the first direction A1-A1, and is also greater than the width of the second ground pad G2 along the first direction A1-A1. With this arrangement, the space of the built-in circuit board 1 can be utilized as much as possible to provide a larger grounding area for improve the shielding effect.

The plurality of first conductive pads 13 further include a third signal conductive pad S3, a fourth signal conductive pad S4 disposed adjacent to the third signal conductive pad S3, a third ground pad G3 disposed adjacent to the third signal conductive pad S3 and located on one side of the third signal conductive pad S3, and a fourth ground pad G4 disposed adjacent to the fourth signal conductive pad S4 and located on one side of the fourth signal conductive pad S4. The third signal conductive pad S3 and the fourth signal conductive pad S4 are arranged side by side along the first direction A1-A1 (for example, the left-right direction) to form a second signal pair DP2. The third ground pad G3 and the fourth ground pad G4 are located on two sides of the second signal pair DP2, respectively, along the first direction A1-A1. In an embodiment of the present disclosure, the second signal pair DP2 is a second differential pair for transmitting signals.

In the illustrated embodiment of the present disclosure, the third ground pad G3 and the fourth ground pad G4 are both in a straight strip shape and extend along the second direction A2-A2 (for example, the front-rear direction). The second direction A2-A2 is perpendicular to the first direction A1-A1. A width of the third ground pad G3 along the first direction A1-A1 is greater than a width of the third signal conductive pad S3 along the first direction A1-A1, and is also greater than a width of the fourth signal conductive pad S4 along the first direction A1-A1. A width of the fourth ground pad G4 along the first direction A1-A1 is greater than the width of the third signal conductive pad S3 along the first direction A1-A1, and is also greater than the width of the fourth signal conductive pad S4 along the first direction A1-A1. With this arrangement, the third ground pad G3 and the fourth ground pad G4 can provide a better shielding effect for the second signal pair DP2, thereby improving the quality of signal transmission.

In the illustrated embodiment of the present disclosure, in order to further improve the quality of signal transmission, the plurality of first conductive pads 13 further include a second connection portion 132 connecting one end of the third ground pad G3 and one end of the fourth ground pad G4, so that the third ground pad G3, the fourth ground pad G4 and the second connection portion 132 are of a U-shaped configuration. The first signal pair DP1 is located in a U-shaped space of the U-shaped configuration.

Specifically, in the illustrated embodiment of the present disclosure, a length of the second connection portion 132 along the second direction A2-A2 is greater than the width of the third ground pad G3 along the first direction A1-A1, is also greater than the width of the fourth ground pad G4 along the first direction A1-A1. With this arrangement, the space of the built-in circuit board 1 can be utilized as much as possible to provide a larger grounding area to improve shielding.

In the illustrated embodiment of the present disclosure, the first signal pair DP1 is located in a first row L1. The second signal pair DP2 is located in a second row L2. The first row L1 and the second row L2 are parallel to each other. The first signal pair DP1 and the second signal pair DP2 are arranged in a staggered manner along the second direction A2-A2. This arrangement is beneficial to reducing crosstalk between the first signal pair DP1 and the second signal pair DP2.

The arrangement manner of the plurality of second conductive pads 14 is the same as the arrangement manner of the plurality of first conductive pads 13, which will not be described again in the present disclosure.

Besides, in the illustrated embodiment of the present disclosure, the built-in circuit board 1 further includes a tongue portion 15. The tongue portion 15 is located at one end (for example, a front end) of the built-in circuit board 1. The tongue portion 15 is configured to be inserted into a mating connector (not shown). A plurality of mating conductive pads 151 are provided on at least one surface of the tongue portion 15.

Besides, as shown in FIG. 8, in one embodiment of the present disclosure, the built-in circuit board 1 further defines a plurality of first holes 161 located on two sides of the first signal conductive pad S1 along the first direction A1-A1, and a plurality of second holes 162 located on two sides of the second signal conductive pad S2 along the first direction A1-A1. The first holes 161 and the second holes 162 are configured to reduce an dielectric constant of the built-in circuit board 1 so as to improve the high-frequency performance of the first signal conductive pad S1 and the second signal conductive pad S2.

Referring to FIG. 8, similarly, in an embodiment of the present disclosure, the built-in circuit board 1 further includes a plurality of third holes 163 located on two sides of the third signal conductive pad S3 along the first direction A1-A1, and a plurality of fourth holes 164 located on two sides of the fourth signal conductive pad S4 along the first direction A1-A1. The third holes 163 and the fourth holes 164 are configured to reduce the dielectric constant of the built-in circuit board 1 so as to improve the high-frequency performance of the third signal conductive pad S3 and the fourth signal conductive pad S4.

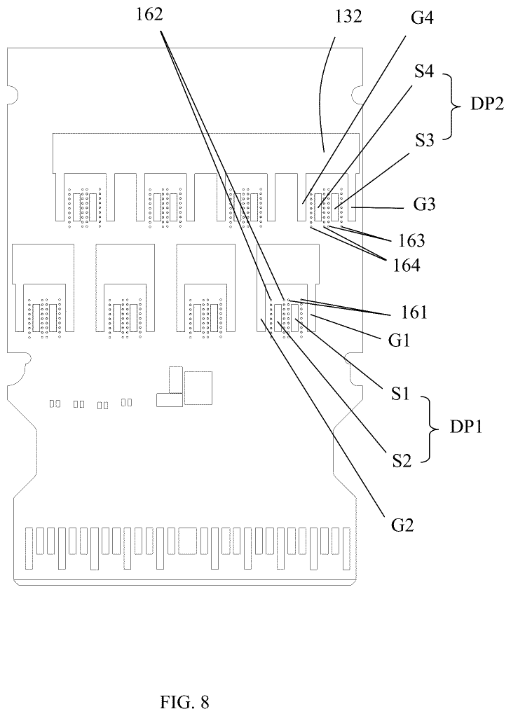

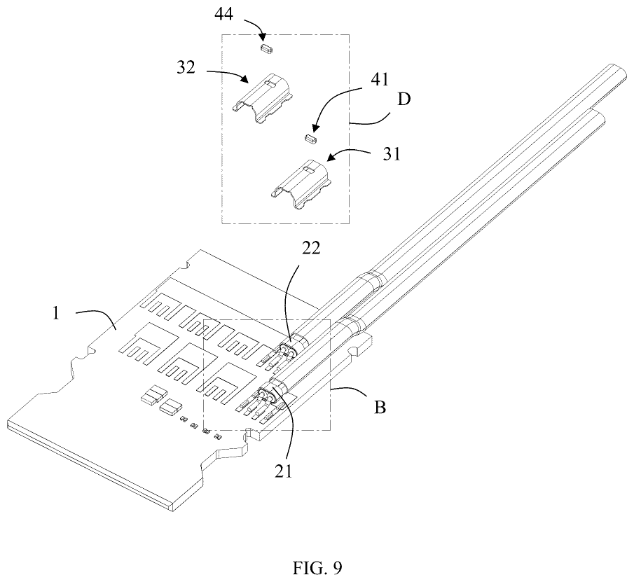

As shown in FIG. 9 to FIG. 18, the plurality of cables include a plurality of first cables 21, a plurality of second cables 22, a plurality of third cables 23 and a plurality of fourth cables 24. The first cable 21 is electrically connected to the first signal conductive pad S1, the second signal conductive pad S2, the first ground pad G1 and the second ground pad G2. The second cable 22 is electrically connected to the third signal conductive pad S3, the fourth signal conductive pad S4, the third ground pad G3 and the fourth ground pad G4. The plurality of third cables 23 and the plurality of fourth cables 24 are electrically connected to the plurality of second conductive pads 14. In order to simplify the description, only one first cable 21 and one second cable 22 located on the same side of the built-in circuit board 1 will be described below.

The first cable 21 includes a first core 211, a second core 212, a first insulation layer 213 wrapped on the first core 211, a second insulation layer 214 wrapped on the second core 212, a first grounding layer 215 located on an outside of the first insulation layer 213 and the second insulation layer 214, a second grounding layer 216 located on an outside of the first insulation layer 213 and the second insulation layer 214, and a third insulation layer 217 located on an outside of the first grounding layer 215 and the second grounding layer 216. In the illustrated embodiment of the present disclosure, both the first grounding layer 215 and the second grounding layer 216 are of flat-shaped configurations, and extend along the second direction A2-A2. The first grounding layer 215 and the second grounding layer 216 are disposed opposite to each other. The first grounding layer 215 is located at an upper portion of the first cable 21. The second grounding layer 216 is located at a lower portion of the first cable 21.

The first core 211 is in electrical contact with the first signal conductive pad S1. The second core 212 is in electrical contact with the second signal conductive pad S2. In an embodiment of the present disclosure, the first core 211 and the first signal conductive pad S1 are fixed by soldering or welding. The second core 212 and the second signal conductive pad S2 are fixed by soldering or welding.

Besides, in the illustrated embodiment of the present disclosure, the third insulation layer 217 defines a first cutout 2170 to divide the third insulation layer 217 into a first end portion 2171 located at one end of the first cutout 2170 and a first body portion 2172 located at another end of the first cutout 2170. Both the first core 211 and the second core 212 extend beyond the first end portion 2171. The first grounding layer 215 and the second grounding layer 216 are at least partially embedded in the first end portion 2171 and the first body portion 2172. The first grounding layer 215 and the second grounding layer 216 are both partially exposed in the first cutout 2170. The first end 2171 is in an integral ring shape to restrain an end of the first grounding layer 215 and an end of the second grounding layer 216, which prevents the first grounding layer 215 and the second grounding layer 216 from becoming cluttered.

Similarly, the second cable 22 includes a third core 221, a fourth core 222, a fourth insulation layer 223 wrapped on the third core 221, a fifth insulation layer 224 wrapped on the fourth core 222, a third grounding layer 225 located on an outside of the fourth insulation layer 223 and the fifth insulation layer 224, a fourth grounding layer 226 located on an outside of the fourth insulation layer 223 and the fifth insulation layer 224, and a sixth insulation layer 227 located on an outside of the third grounding layer 225 and the fourth grounding layer 226. In the illustrated embodiment of the present disclosure, the third grounding layer 225 and the fourth grounding layer 226 are both of flat-shaped configurations, and extend along the second direction A2-A2. The third grounding layer 225 and the fourth grounding layer 226 are arranged opposite to each other. The third grounding layer 225 is located at an upper portion of the second cable 22. The fourth grounding layer 226 is located at a lower portion of the second cable 22.

The third core 221 is in electrical contact with the third signal conductive pad S3, and the fourth core 222 is in electrical contact with the fourth signal conductive pad S4. In an embodiment of the present disclosure, the third core 221 and the third signal conductive pad S3 are fixed by soldering or welding. The fourth core 222 and the fourth signal conductive pad S4 are fixed by soldering or welding.

Furthermore, in the illustrated embodiments of the present disclosure, the sixth insulation layer 227 defines a second cutout 2270 to divide the sixth insulation layer 227 into a second end portion 2271 located at one end of the second cutout 2270 and a second body portion 2272 located at another end of the second cutout 2270. Both the third core 221 and the fourth core 222 extend beyond the second end portion 2271. The third grounding layer 225 and the fourth grounding layer 226 are at least partially embedded in the second end portion 2271 and the second body portion 2272. The third grounding layer 225 and the fourth grounding layer 226 are both partially exposed in the second cutout 2270. The second end 2271 is in an integral ring shape to bind an end of the third grounding layer 225 and an end of the fourth grounding layer 226, which prevents the third grounding layer 225 and the fourth grounding layer 226 from becoming cluttered.

It is understandable to those skilled in the art that by arranging the first signal pair DP1 and the second signal pair DP2 being in the staggered manner along the second direction A2-A2, the first cable 21 and the second cable 22 can be arranged on the same level, thereby avoiding an increase in height due to cable stacking.

The plurality of metal shields include a first metal shield 31, a second metal shield 32, a third metal shield 33 and a fourth metal shield 34. The first metal shield 31 is fastened around a connection position between the first cable 21 and the first conductive pad 13. The second metal shield 32 is fastened around a connection position between the second cable 22 and the first conductive pad 13. The third metal shield 33 is fastened around a connection position between the third cable 23 and the second conductive pad 14. The fourth metal shield 34 is fastened around a connection position between the fourth cable 24 and the second conductive pad 14.

In the illustrated embodiment of the present disclosure, the first metal shield 31 includes a first main body portion 310, a first side wall 311 extending from one side of the first main body portion 310, a first extension portion 313 extending outward from the first side wall 311, a second side wall 312 extending from another side of the first main body portion 310, and a second extension portion 314 extending outward from the second side wall 312. The first metal shield 31 at least partially covers the first cable 21. The first extension portion 313 is in electrical contact with the first ground pad G1. The second extension portion 314 is in electrical contact with the second ground pad G2. The first main body portion 310 defines a first through hole 3101. The first grounding layer 215 is exposed in the first through hole 3101. The cable connector 100 further includes a first fixing component 41 at least partially located in the first through hole 3101 to fix the first main body portion 310 and the first grounding layer 215 together. Preferably, the first fixing component 41 located in the first through hole 3101 is filled with the first through hole 3101 to completely cover a portion of the first grounding layer 215 that is exposed in the first through hole 3101, for further improving the shielding effect. In some embodiments of the present disclosure, the first fixing component 41 includes but is not limited to a solder, a connecting component, and the like. When the first fixing component 41 is the solder, the solder after being melted can better fill the first through hole 3101 based on its fluidity, and fix the first main body portion 310 and the first grounding layer 215 by soldering or welding. Of course, the connecting component may also be a screw or any other element used to fix the first main body portion 310 and the first grounding layer 215.

In the illustrated embodiment of the present disclosure, the first extension portion 313 corresponds to the first ground pad G1. The first extension portion 313 defines at least one first notch 3131. The cable connector 100 includes a solder 42 filled in the first notch 3131 to fix the first extension portion 313 and the first ground pad G1 by soldering or welding. It is understandable to those skilled in the art that the number, shape and size of the first notches 3131 can be flexibly adjusted according to actual needs, which will not be described again in the present disclosure.

Similarly, the second extension portion 314 corresponds to the second ground pad G2. The second extension portion 314 defines at least one second notch 3141. The cable connector 100 includes another solder 43 filled in the second notch 3141 to fix the second extension portion 314 and the second ground pad G2 by soldering or welding. It is understandable to those skilled in the art that the number, shape and size of the second notches 3141 can be flexibly adjusted according to actual needs, which will not be described again in the present disclosure.

In the illustrated embodiment of the present disclosure, the second metal shield 32 includes a second main body portion 320, a third side wall 321 extending from one side of the second main body portion 320, a third extension portion 323 extending outward from the third side wall 321, a fourth side wall 322 extending from another side of the second main body portion 320, and a fourth extension portion 324 extending outward from the fourth side wall 322. The second metal shield 32 at least partially covers the second cable 22. The third extension portion 323 is in electrical contact with the third ground pad G3. The fourth extension portion 324 is in electrical contact with the fourth ground pad G4. The second main body portion 320 defines a second through hole 3201. The third grounding layer 225 is exposed in the second through hole 3201. The cable connector 100 further includes a second fixing member 44 located in the second through hole 3201 to connect the second main body portion 320 and the third grounding layer 225 together. Preferably, the second fixing component 44 located in the second through hole 3201 is filled with the second through hole 3201 to completely cover a portion of the third grounding layer 225 exposed in the second through hole 3201, for further improve the shielding effect. In some embodiments of the present disclosure, the second fixing member 44 includes but is not limited to a solder, a connecting component, and the like. When the second fixing member 44 is the solder, the solder after being melted can better fill the second through hole 3201 based on its fluidity, and fix the second main body portion 320 and the third grounding layer 225 by soldering or welding. Of course, the connecting component may also be a screw or any other element used to fix the second main body portion 320 and the third grounding layer 225.

In the illustrated embodiment of the present disclosure, the third extension portion 323 corresponds to the third ground pad G3. The third extension portion 323 defines at least one third notch 3231. The cable connector 100 includes a solder 45 filled in the third notch 3231 to fix the third extension portion 323 and the third ground pad G3 by soldering or welding. It is understandable to those skilled in the art that the number, shape and size of the third notches 3231 can be flexibly adjusted according to actual needs, which will not be described again in the present disclosure.

Similarly, the fourth extension portion 324 corresponds to the fourth ground pad G4. The fourth extension portion 324 defines at least one fourth notch 3241. The cable connector 100 includes a solder 46 filled in the fourth notch 3241 to fix the fourth extension portion 324 and the fourth ground pad G4 by soldering or welding. It is understandable to those skilled in the art that the number, shape and size of the fourth notches 3241 can be flexibly adjusted according to actual needs, which will not be described again in the present disclosure.

In the illustrated embodiment of the present disclosure, the second metal shield 32 is the same as the first metal shield 31 to share parts and reduce costs.

Compared with the prior art, some embodiments of the present disclosure is provided with the first metal shield 31. The first metal shield 31 includes the first main body portion 310, the first side wall 311 extending from one side of the first main body portion 310, the first extension portion 313 extending outward from the first side wall 311, the second side wall 312 extending from the another side of the first main body portion 310, and the second extension portion 314 extending outward from the second side wall 312. The first metal shield 31 at least partially covers the first cable 21. The first extension portion 313 is in electrical contact with the first ground pad G1. The second extension portion 314 is in electrical contact with the second ground pad G2. The first main body portion 310 defines the first through hole 3101. The first grounding layer 215 is exposed in the first through hole 3101. The cable connector 100 includes the first fixing component 41 at least partially located in the first through hole 3101 to fix the first main body portion 310 and the first grounding layer 215 together. With this arrangement, the cable connector 100 of some embodiments of the present disclosure has a better shielding effect.

The second metal shield 32 can achieve a similar shielding effect as the first metal shield 31, which will not be described again in the present disclosure.

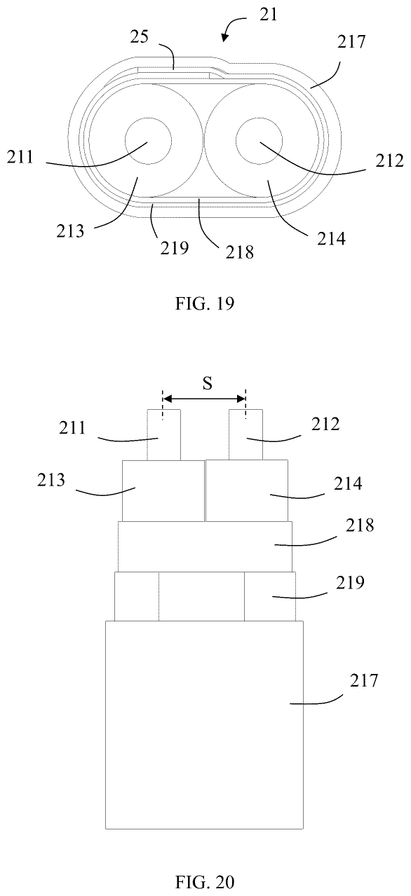

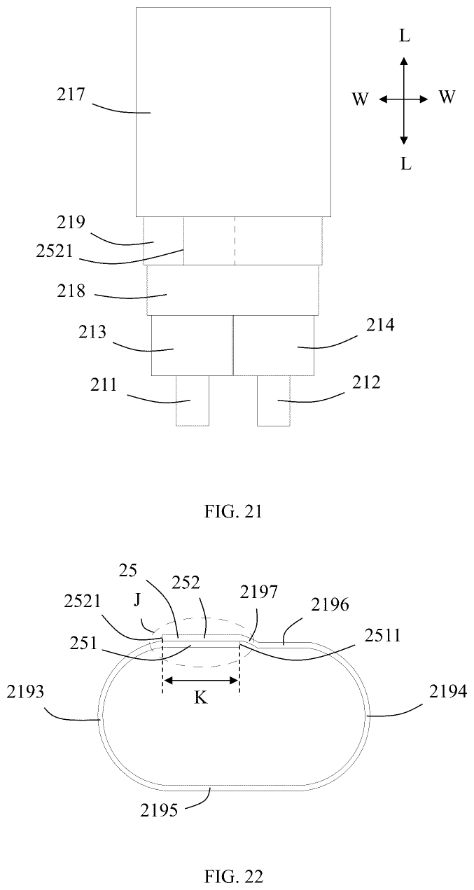

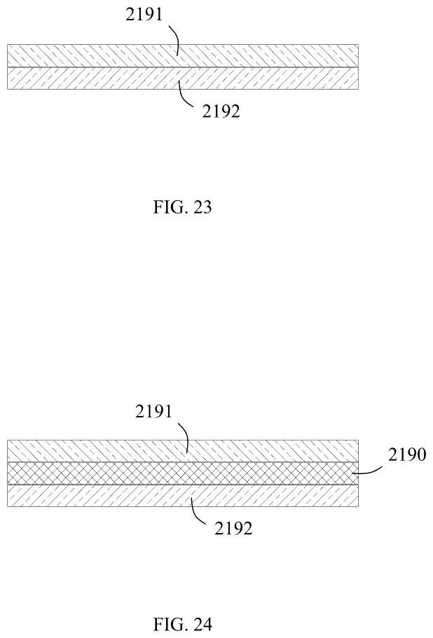

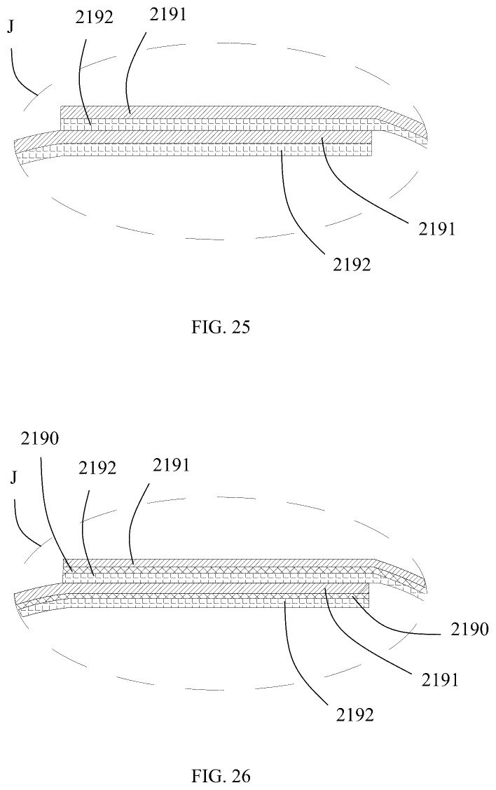

Referring to FIG. 19 to FIG. 26, in a second embodiment of the first cable 21 of the cable connector 100, the first cable 21 includes a first core 211, a second core 212, a first insulation layer 213 at least partially surrounding the first core 211 in a circumferential direction, a second insulation layer 214 at least partially surrounding the second core 212 in a circumferential direction, an intermediate layer 218 at least partially surrounding the first insulation layer 213 and the second insulation layer 214 in a circumferential direction, a shielding layer 219 is at least partially surrounding the intermediate layer 218 in a circumferential direction, and a third insulation layer 217 located outside the shielding layer 219 in a circumferential direction.

In the illustrated embodiment of the present disclosure, the first core 211 and the second core 212 are both cylindrical. The first core 211 is configured to transmit a first signal, and the second core 212 is configured to transmit a second signal. In one embodiment of the present disclosure, the first signal and the second signal form a high-speed differential pair. In one embodiment of the present disclosure, the first core 211 and the second core 212 are silver-plated metal conductors (for example, silver-plated copper wires) to improve the quality of signal transmission.

In the illustrated embodiment of the present disclosure, the first insulation layer 213 and the second insulation layer 214 are arranged separately. Both the first insulation layer 213 and the second insulation layer 214 extend in a longitudinal direction L-L (i.e., the second direction A2-A2). The first insulation layer 213 and the second insulation layer 214 are disposed adjacent to each other, parallel to each other, and in contact with each other. The first insulation layer 213 and the second insulation layer 214 are arranged side by side in a width direction W-W (i.e., the first direction A1-A1) perpendicular to the longitudinal direction L-L. Both the first insulation layer 213 and the second insulation layer 214 are cylindrical. In one embodiment of the present disclosure, the first insulation layer 213 is a polyolefin or a fluoropolymer. The second insulation layer 214 is a polyolefin or a fluoropolymer. Materials of the first insulation layer 213 and the second insulation layer 214 may be the same or different. Of course, it is understandable to those skilled in the art that in other embodiments of the present disclosure, the first insulation layer 213 and the second insulation layer 214 may also be formed into a whole insulation layer, such as an oval insulation layer.

In one embodiment of the present disclosure, the intermediate layer 218 is at least partially wound or is sleeved on the first insulation layer 213 and the second insulation layer 214. The intermediate layer 218 is a buffer insulation layer disposed outside the first insulation layer 213 and the second insulation layer 214. The intermediate layer 218 has an insulating and buffering function.

In one embodiment of the present disclosure, the intermediate layer 218 is made of foam polyolefins, such as foam polypropylene. The intermediate layer 218 is wound spirally on the first insulation layer 213 and the second insulation layer 214 in the longitudinal direction L-L of the first cable 21. Specifically, the intermediate layer 218 is continuously wound on the first insulation layer 213 and the second insulation layer 214 along the longitudinal direction L-L of the first cable 21. Of course, in other embodiments, the intermediate layer 218 may also be directly sleeved on the first insulation layer 213 and the second insulation layer 214.

In one embodiment of the present disclosure, the shielding layer 219 includes at least a first metal layer 2191 located on an outer side thereof, and a second metal layer 2192 located on an inner side thereof. The first metal layer 2191 and the second metal layer 2192 have the same or different metal materials. The first metal layer 2191 and the second metal layer 2192 are directly or indirectly integrated as a whole. Specifically, the first metal layer 2191 is located at an outer layer of the shielding layer 219 that is away from the first core 211 and the second core 212. The second metal layer 2192 is located at an inner layer of the shielding layer 219 that is disposed adjacent to the first core 211 and the second core 212.

In one embodiment of the present disclosure, the shielding layer 219 includes the first metal layer 2191 and the second metal layer 2192, which not only increases the thickness of the shielding layer 219, but also improves the shielding effect of the first cable 21, and improves the reliability of signal transmission. The first metal layer 2191 and the second metal layer 2192 are directly integrated as a whole via high temperature and high pressure. For example, the shielding layer 219 may be an integrated high-temperature and high-pressure composite layer. In another embodiment of the present disclosure, the shielding layer 219 includes a base film 2190. The first metal layer 2191 and the second metal layer 2192 are composited on opposite surfaces of the base film 2190, respectively. The first metal layer 2191 and the second metal layer 2192 are composited on the opposite surfaces of the base film 2190 via adhesive. For example, the shielding layer 219 may be an adhesive composite layer. In one embodiment of the present disclosure, the shielding layer 219 is a non-full metal conductive material, such as a conductive weaving, a conductive plastic, or a conductive foam.

The base film 2190 may be made of a polyester material, for example, of polyethylene terephthalate. The first metal layer 2191 is located at the outer layer of the shielding layer 219 that is away from the first core 211 and the second core 212. The second metal layer 2192 is located at the inner layer of the shielding layer 219 that is disposed adjacent to the first core 211 and the second core 212.

In the illustrated embodiment of the present disclosure, the shielding layer 219 is a double-sided conductive aluminum foil. That is, the first metal layer 2191 and the second metal layer 2192 are both aluminum foil in order to solve the problem that the shielding layer 219 is prone to cracking when using a composite strip structure. In one embodiment of the present disclosure, the shielding layer 219 is a double-sided conductive copper foil.

In the illustrated embodiment of the present disclosure, the shielding layer 219 includes two joints and an overlapping area 25. The overlapping area 25 is formed by superimposing the two joints of the shielding layer 219 to improve electrical performance. In one embodiment of the present disclosure, one of the joints is a first joint 251 and a remaining one of the joints is a second joint 252. The second joint 252 is superimposed on the first joint 251. The aluminum foil of the first joint 251 and the aluminum foil of the second joint 252 are in contact with each other to achieve contact conduction.

Specifically, the first joint 251 is disposed adjacent to the second joint 252 and the second core 212. The first metal layer 2191 of the first joint 252 is disposed adjacent to the first core 211 and the second core 212 relative to the second metal layer 2192 of the second joint 252. The first metal layer 2191 of the first joint 251 and the second metal layer 2192 of the second joint 252 are in contact with each other.

In the illustrated embodiment of the present disclosure, a distance between a central axis of the first core 211 and a central axis of the second core 212 is S. The first joint 251 has a first end face 2511. The second joint 252 has a second end face 2521. A distance between the first end surface 2511 and the second end surface 2521 in the width direction W-W is K, where S>K.

In one embodiment of the present disclosure, the shielding layer 219 includes a first arc portion 2193, a second arc portion 2194 disposed opposite the first arc portion 2193, a first straight portion 2195 connecting one side of the first arc portion 2193 and one side of the second arc portion 2194, and a connection area disposed opposite to the first straight portion 2195. The connection area includes the overlapping area 25 and the second straight portion 2196. The first joint 251 may be connected to the first arc portion 2193 or the second straight portion 2196. Opposite sides of the second straight portion 2196 are connected to the second arc portion 2194 and the second joint 252, respectively. As shown in FIG. 22, the shielding layer 219 has a circumference, which is defined as a length extending in a circumferential direction on a plane perpendicular to the longitudinal direction L-L. For example, on a plane of FIG. 22, from the first end surface 2511, along the length of the first joint 251, the first arc portion 2193, the first straight portion 2195, the second arc portion 2194, the second straight portion 2196, a lifting portion 2197 and the second joint 252. In one embodiment of the present disclosure, a ratio of the distance K of the overlapping area 25 to the circumference of the shielding layer 219 is an overlap ratio. The overlap ratio can be set to be between 10% and 50%. With such a configuration, the first cable 21 can achieve a better balance in the comprehensive performance of cross-talk, insertion loss and signal symmetry (referring to SCD21 parameters). For example, if the overlap ratio is too low, crosstalk problems are likely to occur. If the overlap ratio is too high, it is easy to cause the symmetry problem of the signal.

In the illustrated embodiment of the present disclosure, the connection area further includes the lifting portion 2197. Opposite sides of the lifting portion 2197 are connected to the second joint 252 and the second straight portion 2196, respectively. The lifting portion 2197 gradually moves away from the first core 211 and the second core 212 from the second straight portion 2196 to the second joint 252. In some embodiments, the second joint 252 protrudes away from the first core 211 and the second core 212 by the lifting portion 2197, so that the first metal layer 2191 outside the second joint 252 is more easily connected to a grounding part of the connector, thereby improving the ground shielding effect.

In the illustrated embodiment of the present disclosure, by setting the shielding layer 219 as a double-sided conductive aluminum foil, the problem that the shielding layer 219 is prone to crack, when bending and using the composite strip structure, is solved.

In the illustrated embodiment of the present disclosure, the first cable 21 does not have a ground wire.

In one embodiment of the present disclosure, the third insulation layer 217 is an insulation layer located on the outermost side of the first cable 21. The third insulation layer 217 may be made of a polyester material. In one embodiment of the present disclosure, the third insulation layer 217 may be made of a polyimide material.

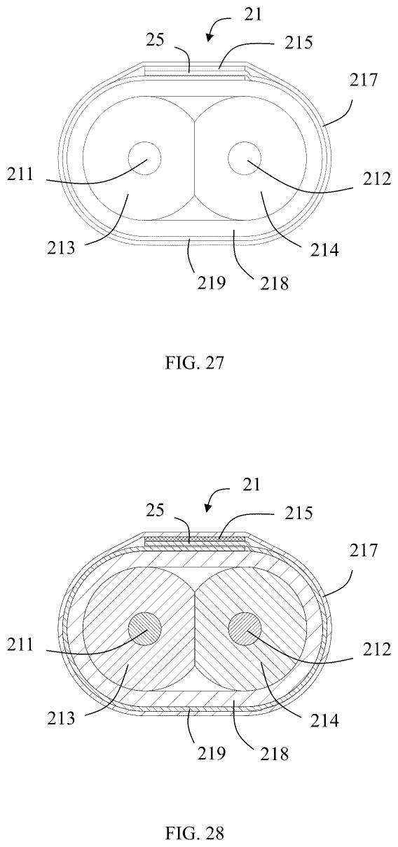

Referring to FIG. 27 and FIG. 28, in a third embodiment of the first cable 21 of the cable connector 100, the first cable 21 includes a first core 211, a second core 212, a first insulation layer 213 at least partially surrounding the first core 211 in a circumferential direction, a second insulation layer 214 at least partially surrounding the second core 212 in a circumferential direction, an intermediate layer 218 at least partially surrounding the first insulation layer 213 and the second insulation layer 214 in a circumferential direction, a shielding layer 219 at least partially surrounding the intermediate layer 218 in a circumferential direction, a first grounding layer 215 located outside the shielding layer 219, and a third insulation layer 217 located at an outer layer of the first grounding layer 215 in a circumferential direction. The cable connector 100 in the third embodiment of the present disclosure is basically similar to the cable connector 100 in the second embodiment of the present disclosure, in which for the same or corresponding technical features, please refer to the description of the cable connector 100 in the second embodiment of the present disclosure, and will not be repeated in detail in the present disclosure. The main difference between the cable connector 100 in the third embodiment of the present disclosure and the cable connector 100 in the second embodiment of the present disclosure is that the cable connector 100 in the third embodiment of the present disclosure also includes the first grounding layer 215 which will be described in detail below.

In the illustrated embodiment of the present disclosure, the first grounding layer 215 is flat and extends in a flat strip shape along a longitudinal direction L-L. The first grounding layer 215 is located on an upper part of the first cable 21. In one embodiment of the present disclosure, the first grounding layer 215 is a copper strip or copper foil, so the first grounding layer 215 is suitable for soldering or welding, which can be connected to a grounding structure outside the first cable 21 by soldering or welding, for example, by tin material. In one embodiment of the present disclosure, the first grounding layer 215 is exposed to the first through hole 3101. The first fixing component 41 is soldered and is located in the first through hole 3101, and the first fixing component 41 is connected to the first main body portion 310 and the first grounding layer 215 by soldering or welding. In one embodiment of the present disclosure, the first grounding layer 215 is a tin-plated copper strip, and its surface layer is tinned so that it can be directly soldered or welded to the grounding structure outside the first cable 21.

In one embodiment of the present disclosure, the shielding layer 219 may refer to the second embodiment of the first cable 21 in FIG. 19 to FIG. 26. The shielding layer 219 includes a first metal layer 2191 located on an outer side thereof, and a second metal layer 2192 located on an inner side thereof. The metal material of the first metal layer 2191 may be the same or different from the metal material of the second metal layer 2192. The metal material of the first metal layer 2191 may be the same or different from the metal material of the first grounding layer 215. The metal material of the second metal layer 2192 may be the same or different from the metal material of the first grounding layer 215.

In one embodiment of the present disclosure, the first metal layer 2191 includes aluminum, or other metal material that is non-copper. The second metal layer 2192 includes aluminum, or other metal material that is non-copper. The first grounding layer 215 includes copper. For example, the first metal layer 2191 and the second metal layer 2192 are both aluminum foil, and the first grounding layer 215 is a copper strip or copper foil. In one embodiment of the present disclosure, the first metal layer 2191, the second metal layer 2192, and the first grounding layer 215 both include copper. For example, the first metal layer 2191 and the second metal layer 2192 are both copper foils. The first grounding layer 215 is a copper strip or a copper foil.

In one embodiment of the present disclosure, the metal material of the first metal layer 2191 and the metal material of the second metal layer 2192 are different from the metal material of the first grounding layer 215. In the illustrated embodiment of the present disclosure, the metal material of the first metal layer 2191 is the same as the metal material of the second metal layer 2192, and are both aluminum foils. The metal material of the first grounding layer 215 is a copper strip.

In one embodiment of the present disclosure, the shielding layer 219 may be a single layer of first metal layer 2191. The first metal layer 2191 is in contact with the intermediate layer 218. The first grounding layer 215 is in contact with the first metal layer 2191. The metal material of the first metal layer 2191 may be the same or different from the metal material of the first grounding layer 215. For example, the first metal layer 2191 is aluminum foil, and the first grounding layer 215 is a copper foil or a copper strip. Alternatively, for example, the first metal layer 2191 is copper foil, and the first grounding layer 215 is a copper foil or a copper strip.

In one embodiment of the present disclosure, the shielding layer 219 may be a composite structure of the base film 2190 and the first metal layer 2191. The base film 2190 is in contact with the intermediate layer 218. The first grounding layer 215 is in contact with the first metal layer 2191. The metal material of the first metal layer 2191 may be the same or different from the metal material of the first grounding layer 215. For example, the first metal layer 2191 is aluminum foil, the first grounding layer 215 is a copper foil or a copper strip, and the base film 2190 is a non-metallic material. Alternatively, for example, the first metal layer 2191 is a copper foil, and the first grounding layer 215 is a copper foil or a copper strip.

In one embodiment of the present disclosure, the shielding layer 219 may be a composite structure of the base film 2190 and the second metal layer 2192. The second metal layer 2192 is in contact with the intermediate layer 218. The first grounding layer 215 is in contact with the base film 2190. The metal material of the second metal layer 2192 may be the same or different from the metal material of the first grounding layer 215. For example, the second metal layer 2192 is an aluminum foil, the first grounding layer 215 is a copper foil, and the base film 2190 is a non-metallic material. Alternatively, for example, the second metal layer 2192 is a copper foil, and the first grounding layer 215 is a copper foil or a copper strip.

In one embodiment of the present disclosure, the shielding layer 219 may be a single-layer base film 2190. The base film 2190 is a non-full metal conductive material, such as a conductive weaving cloth, a conductive plastic or a conductive foam. The base film 2190 is in contact with the intermediate layer 218. The first grounding layer 215 is in contact with the base film 2190.

The first grounding layer 215 is in contact with the shielding layer 219. In the illustrated embodiment of the present disclosure, by setting the shielding layer 219 as a single layer/single-sided conductive aluminum foil or a double-layer/double-sided conductive aluminum foil, the problem that the shielding layer 219 is prone to crack, when bending and using a composite strip structure, is solved. In addition, by providing the first grounding layer 215, the problem of aluminum foil solder or welding is solved. In other words, the shielding layer 219 is made of aluminum foil, which can cause soldering or welding difficulties. If the shielding layer 219 has the copper foil, the copper foil will easily crack when the wire is bent. The shielding layer 219 of the single-layer/single-sided conductive aluminum foil or the double-layer/double-sided conductive aluminum foil, and the first grounding layer 215 of a flat tin-plated copper strip used in the specific embodiment of the present disclosure cleverly solves the above problems. The first cable 21 of the present disclosure has a low loss tight coupling structure, which is suitable for transmitting high-speed signals.

In the illustrated embodiment of the present disclosure, the first cable 21 does not have a ground wire. At least a portion of the first grounding layer 215 is configured as a grounding element of the first cable 21. In the illustrated embodiment of the present disclosure, the first grounding layer 215 is configured as the grounding element of the first cable 21. Alternatively, at least a portion of the first grounding layer 215 is configured to be in contact with an external grounding element. In the illustrated embodiment of the present disclosure, the first grounding layer 215 and the shielding layer 219 are arranged separately. The material selection of the first grounding layer 215 can be achieved according to its own needs, and the material selection of the shielding layer 219 can also be achieved according to its own needs, thereby reducing the difficulty of selecting the respective materials of the first grounding layer 215 and the shielding layer 219, and improving the flexibility of the design.

In one embodiment of the present disclosure, the shielding layer 219 includes an overlapping area 25. The overlapping area 25 may refer to the second embodiment of the first cable 21 shown in FIG. 19 to FIG. 26. The first grounding layer 215 is disposed at the outer layer of the overlapping area 25, and is in contact with the overlapping area 25, but the present disclosure is not limited thereto. In other embodiments, the first grounding layer 215 is disposed on an opposite side of the overlapping area 25 without contacting the overlapping area 25.

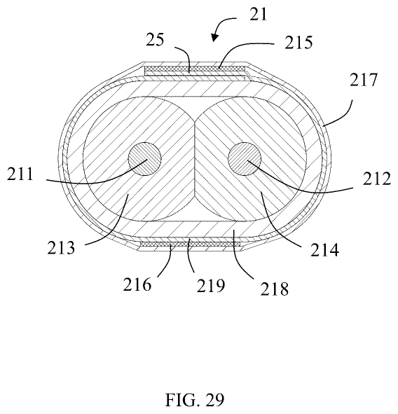

Referring to FIG. 29, in a fourth embodiment of the first cable 21 of the cable connector 100, the first cable 21 includes a first core 211, a second core 212, a first insulation layer 213 at least partially surrounding the first core 211 in a circumferential direction, a second insulation layer 214 at least partially surrounding the second core 212 in a circumferential direction, an intermediate layer 218 at least partially surrounding the first insulation layer 213 and the second insulation layer 214 in a circumferential direction, a shielding layer 219 at least partially surrounding the intermediate layer 218 in a circumferential direction, a first grounding layer 215 located outside the shielding layer 219, a second grounding layer 216 located outside the shielding layer 219, and a third insulation layer 217 located outside the first grounding layer 215 and the second grounding layer 216 in a circumferential direction. The cable connector 100 in the third embodiment of the present disclosure is basically similar to the cable connector 100 in the second embodiment of the present disclosure, in which for the same or corresponding technical features, please refer to the description of the cable connector 100 in the second embodiment of the present disclosure, and will not be repeated in detail in the present disclosure. The main difference between the cable connector 100 in the fourth embodiment of the present disclosure, and the cable connector 100 in the third embodiment of the present disclosure is that the cable connector 100 in the fourth embodiment of the present disclosure also includes the second grounding layer 216.

In the illustrated embodiment of the present disclosure, the first grounding layer 215 and the second grounding layer 216 are both flat, and extend in a flat strip shape along the longitudinal direction L-L. The first grounding layer 215 is disposed opposite to the second grounding layer 216. The first grounding layer 215 is located on an upper part of the first cable 21, and the second grounding layer 216 is located at a lower part of the first cable 21. In one embodiment of the present disclosure, the first grounding layer 215 and the second grounding layer 216 are both copper strips or copper foils. The metal material of the first metal layer 2191 is different from the metal material of the first grounding layer 215. The metal material of the second metal layer 2192 is different from the metal material of the second grounding layer 216. In the illustrated embodiment of the present disclosure, the metal material of the first metal layer 2191 is the same as the metal material of the second metal layer 2192, and both are aluminum foils. The metal material of the first grounding layer 215 is the same as the metal material of the second grounding layer 216, and both are copper strips or copper foils.

The first grounding layer 215 and the second grounding layer 216 are in contact with the shielding layer 219. In the illustrated embodiment of the present disclosure, by setting the shielding layer 219 as a double-sided conductive aluminum foil, the problem that the shielding layer 219 is prone to crack, when bending and using the composite strip structure, is solved. In addition, by providing the first grounding layer 215 and the second grounding layer 216, the problem of aluminum foil soldering or welding is solved. In other words, the shielding layer 219 is made of aluminum foil, which can cause soldering or welding difficulties. If the shielding layer 219 has copper foil, the copper foil will easily crack when the wire is bent. The above problems are cleverly solved by the shielding layer 219 of the double-sided conductive aluminum foil, the first grounding layer 215 and the second grounding layer 216 of the copper tape, used in the specific embodiment of the present disclosure. The first cable 21 disclosed herein has a low loss tight coupling structure, which is suitable for transmitting high-speed signals.

In the illustrated embodiment of the present disclosure, the first cable 21 does not have a ground wire. At least a portion of the first grounding layer 215 and/or the second grounding layer 216 are configured as grounding elements of the first cable 21. In the illustrated embodiment of the present disclosure, the first grounding layer 215 and the second grounding layer 216 are both configured as grounding elements of the first cable 21. In the illustrated embodiment of the present disclosure, the first grounding layer 215 and the second grounding layer 216 are arranged separately from the shielding layer 219. The material selection of the first grounding layer 215 can be achieved according to its own needs; the material selection of the second grounding layer 216 can be achieved according to its own needs; and the material selection of the shielding layer 219 can also be achieved according to its own needs, thereby reducing the difficulty of selecting the respective materials of the first grounding layer 215, the second grounding layer 216, and the shielding layer 219, and improving the design flexibility.

In one embodiment of the present disclosure, the shielding layer 219 includes an overlapping area 25 which may be referred to that in the second embodiment of the first cable 21 shown in FIG. 19 to FIG. 26. The first grounding layer 215 is disposed at an outer layer of the overlapping area 25, and is in contact with the overlapping area 25. The second grounding layer 216 is disposed on an opposite side of the overlapping area 25.

Some embodiments of the present disclosure discloses a manufacturing method of the first cable 21, which includes:
providing a first core 211, and wrapping a first insulation layer 213 around the first core 211;
providing a second core 212, and wrapping a second insulation layer 214 around the second core 212;
providing a shielding layer 219, and enclosing a shielding layer 219 on the first insulation layer 213 and the second insulation layer 214;
providing a first grounding layer 215, and attaching a first grounding layer 215 to one side of the shielding layer 219; and
providing a third insulation layer 217, and disposing the third insulation layer 217 outside of the first grounding layer 215.

In one embodiment of the present disclosure, the manufacturing method of the first cable 21 further includes providing an intermediate layer 218, and wrapping the intermediate layer 218 around the first insulation layer 213 and the second insulation layer 214; and wrapping the shielding layer 219 around the intermediate layer 218.

In one embodiment of the present disclosure, the shielding layer 219 is wrapped around the intermediate layer 218 in the circumferential direction.

In one embodiment of the present disclosure, when the shielding layer 219 is wrapped in the circumferential direction, the second joint 252 is further superimposed on the first joint 251 to form an overlapping area 25.

In one embodiment of the present disclosure, the first grounding layer 215 is attached to one side of the shielding layer 219 in the longitudinal direction L-L.

In one embodiment of the present disclosure, the first grounding layer 215 is attached to an outer layer of the overlapping area 25 of the shielding layer 219 in the longitudinal direction L-L.

Some embodiments of the present disclosure also discloses another manufacturing method of the first cable 21, which includes:
providing a first core 211, and wrapping a first insulation layer 213 around the first core 211;
providing a second core 212, and wrapping a second insulation layer 214 around the second core 212;
providing an intermediate layer 218, and wrapping the intermediate layer 218 around the first insulation layer 213 and the second insulation layer 214;
providing a shielding layer 219, and wrapping the shielding layer 219 around the intermediate layer 218;
providing a first grounding layer 215 and a second grounding layer 216, and attaching the first grounding layer 215 and the second grounding layer 216 to two sides of the shielding layer 219; and
providing a third insulation layer 217, and disposing the third insulation layer 217 outside the first grounding layer 215 and the second grounding layer 216.

It is understandable to those skilled in the art that the relevant steps involved in the manufacturing method of the first cable 21 described above can be flexibly adjusted as needed.

In the illustrated embodiment of the present disclosure, the structures of the second cable 22, the third cable 23 and the fourth cable 24 are the same as those of the first cable 21, which will not be repeated here in the present disclosure.

Some embodiments of the present disclosure also discloses a method of manufacturing the above-mentioned cable connector 100, including:
providing a built-in circuit board 1, the built-in circuit board 1 including a first surface 11 and a plurality of first conductive pads 13 exposed on the first surface 11; the plurality of first conductive pads 13 including a first signal conductive pad S1, a second signal conductive pad S2 disposed adjacent to the first signal conductive pad S1, a first ground pad G1 disposed adjacent to the first signal conductive pad S1 and located on one side of the first signal conductive pad S1, and a second ground pad G2 disposed adjacent to the second signal conductive pad S2 and located on one side of the second signal conductive pad S2; the first signal conductive pad S1 and the second signal conductive pad S2 being arranged side by side along the first direction A1-A1 to form a first signal pair DP1; the first ground pad G1 and the second ground pad G2 are located on two sides of the first signal pair DP1, respectively, along the first direction A1-A1;
providing a first cable 21, the first cable 21 including a first core 211, a second core 212, a first insulation layer 213 wrapped on the first core 211, a second insulation layer 214 wrapped on the second core 212, and a first grounding layer 215 located on an outside of the first insulation layer 213 and the second insulation layer 214; the first core 211 and the first signal conductive pad S1 being fixed by soldering or welding, and the second core 212 and the second signal conductive pad S2 being fixed by soldering or welding;
providing prefabricated solders 42 and 43, and putting the prefabricated solders 42 and 43 on the first ground pad G1 and the second ground pad G2, respectively;
providing a first metal shield 31, the first metal shield 31 including a first main body portion 310, a first side wall 311 extending from one side of the first main body portion 310, a first extension portion 313 extending outward from the first side wall 311, a second side wall 312 extending from another side of the first main body portion 310, and a second extension portion 314 extending outward from the second side wall 312; the first main body portion 310 defining a first through hole 3101; the first metal shield 32 being at least partially covered on the first cable 21 so that the first grounding layer 215 is exposed in the first through hole 3101;
melting the prefabricated solders 42 and 43, so that the first extension portion 313 and the first ground pad G1 are fixed together, and the second extension portion 314 and the second ground pad G2 are fixed together; and
providing a first fixing component 41 which is at least partially installed into the first through hole 3101; the first main body portion 310 and the first grounding layer 215 are fixed together through the first fixing component 41.

It is understandable to those skilled in the art that, taking the first metal shield 31 as an example, the first notch 3131 and the second notch 3141 of the first metal shield 31 correspond to the prefabricated solders 42 and 43, respectively. When the prefabricated solders 42 and 43 are melted, the solders 42 and 43 can be filled into the first notch 3131 and the second notch 3141, and the soldering process can be observed from the outside, thereby facilitating identification the quality of soldering or welding.

The second metal shield 32, the third metal shield 33 and the fourth metal shield 34 are assembled in the same manner as the first metal shield 31, and will not be described again in the present disclosure.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A cable, comprising:
a first core;
a second core;
a first insulation layer, the first insulation layer at least partially surrounding the first core;
a second insulation layer, the second insulation layer at least partially surrounding the second core;
a shielding layer, the shielding layer being located outside the first insulation layer and the second insulation layer, and the shielding layer at least partially surrounding the first insulation layer and the second insulation layer; and
a first grounding layer, the first grounding layer being of a flat configuration and extending in a longitudinal direction of the cable as a flat strip; the first grounding layer being located outside the shielding layer; and the first grounding layer being separate from and in contact with the shielding layer.

2. The cable according to claim 1, wherein the cable is devoid of a ground wire, and the first grounding layer serves as a grounding component of the cable.

3. The cable according to claim 1, wherein the shielding layer comprises a first metal layer.

4. The cable according to claim 3, wherein the first metal layer is an aluminum foil or a copper foil, and the first grounding layer is a copper strip.

5. The cable according to claim 3, wherein the shielding layer comprises a second metal layer; the first metal layer and the second metal layer are composited together; one of the first metal layer and the second metal layer is located on an inner side of the shielding layer, and the other one of the first metal layer and the second metal layer is located on an outer side of the shielding layer.

6. The cable according to claim 5, wherein the first metal layer is an aluminum foil or a copper foil; and the second metal layer is an aluminum foil or a copper foil.

7. The cable according to claim 5, wherein one of the first metal layer and the second metal layer is an aluminum foil, and a remaining one of the first metal layer and the second metal layer is a copper foil.

8. The cable according to claim 5, wherein the first metal layer and the second metal layer are composited together directly.

9. The cable according to claim 5, wherein the shielding layer comprises a base film, and the first metal layer and the second metal layer are composited on opposite surfaces of the base film, respectively.

10. The cable according to claim 1, further comprising a second grounding layer, the second grounding layer being of a flat configuration and extending in the longitudinal direction of the cable as a flat strip; the second grounding layer being located outside the shielding layer and in contact with the shielding layer; the second grounding layer being a copper strip; wherein the first grounding layer and the second grounding layer are located on opposite sides of the shielding layer.

11. The cable according to claim 10, further comprising a third insulation layer located outside the first grounding layer and the second grounding layer.

12. The cable according to claim 1, wherein the shielding layer comprises a first joint, a second joint and an overlapping area; and the overlapping area is formed by overlapping the first joint and the second joint of the shielding layer.

13. The cable according to claim 12, wherein the first grounding layer is disposed outside the overlapping area and in contact with the overlapping area.

14. The cable according to claim 1, further comprising an intermediate layer wound around the first insulation layer and the second insulation layer, wherein the shielding layer is located outside the intermediate layer.

15. A method for manufacturing a cable, the cable comprising:
a first core;
a second core;
a first insulation layer at least partially surrounding the first core;
a second insulation layer at least partially surrounding the second core;
a shielding layer located outside the first insulation layer and the second insulation layer, and the shielding layer at least partially surrounding the first insulation layer and the second insulation layer in the circumferential direction; and
a first grounding layer, the first grounding layer being of a flat configuration and extending in a longitudinal direction of the cable as a flat strip; the first grounding layer being located outside the shielding layer; and the first grounding layer being separate from and in contact with the shielding layer;
the method comprising:
providing the first core and wrapping the first insulation layer around the first core;
providing the second core and wrapping the second insulation layer around the second core;
providing the shielding layer and disposing the shielding layer outside the first insulation layer and the second insulation layer; and
providing the first grounding layer and attaching the first grounding layer to an outer side of the shielding layer.

16. The method for manufacturing the cable according to claim 15, wherein attaching the first grounding layer to the outer side of the shielding layer further comprises attaching the first grounding layer to a side of the shielding layer along the longitudinal direction of the cable.

17. The method for manufacturing the cable according to claim 15, wherein the cable is devoid of a ground wire, and the first grounding layer serves as a grounding component of the cable.

18. The method for manufacturing the cable according to claim 15, wherein the shielding layer comprises a first metal layer and a second metal layer;
the first metal layer is an aluminum foil or a copper foil, and the first grounding layer is a copper strip;
the first metal layer and the second metal layer are composited together; one of the first metal layer and the second metal layer is located on an inner side of the shielding layer, and a remaining one of the first metal layer and the second metal layer is located on an outer side of the shielding layer.

19. The method for manufacturing the cable according to claim 18, wherein one of the first metal layer and the second metal layer is an aluminum foil, and a remaining one of the first metal layer and the second metal layer is a copper foil; and wherein the first metal layer and the second metal layer are composited together directly.

20. The method for manufacturing the cable according to claim 15, wherein the cable further comprises a second grounding layer, the second grounding layer is of a flat configuration and extends in the longitudinal direction of the cable as a flat strip; the second grounding layer is located outside the shielding layer and in contact with the shielding layer; the second grounding layer is a copper strip; wherein the first grounding layer and the second grounding layer are located on opposite sides of the shielding layer.
